(19) United States
(12) Patent Application Publication
(10) Pub. No.: US 2025/0371439 A1
(43) Pub. Date: Dec. 4, 2025

(54) MODEL TRAINING METHOD, MEDIUM, AND ELECTRONIC DEVICE

(71) Applicant: Beijing Volcano Engine Technology Co., Ltd., Beijing (CN)

(72) Inventors: Junjie SHI, Beijing (CN); Qingyou YANG, Beijing (CN); Keyu YANG, Beijing (CN); Yang LIU, Beijing (CN); Jue HONG, Beijing (CN); Ye WU, Beijing (CN)

(21) Appl. No.: 19/060,552

(22) Filed: Feb. 21, 2025

(30) Foreign Application Priority Data
May 31, 2024 (CN) 202410702816.2

(51) Int. Cl. G06N 20/20

(52) U.S. Cl. CPC G06N 20/20

(57) ABSTRACT

The present disclosure relates to a model training method and a system based on federated learning, and an electronic device, the method includes: acquiring a sample intersection identifier list; determining a first sample subset and a sample subset identifier corresponding to the first sample subset based on the sample intersection identifier list and an original sample subset; and transmitting the sample subset identifier to a second trainer paired with the first trainer, so that the second trainer determines a second sample subset based on the sample subset identifier and the original sample set of the second participant, in which the first sample subset and the second sample subset are used for model training based on federated learning of the first trainer and the second trainer.

### CROSS REFERENCE TO RELATED APPLICATION(S)

This application claims priority to Chinese Application No. 202410702816.2 filed on May 31, 2024, the disclosure of which is incorporated herein by reference in its entirety.

### TECHNICAL FIELD

The present disclosure relates to a model training method, a system and an apparatus based on federated learning, and an electronic device.

### BACKGROUND

Federated learning is a technology which promotes a plurality of data owners to collaborate on model training in a way that protects the security of original data, which is conducive to data sharing and cooperation, and solve the problem of data silos.

Taking a vertical federated learning system as an example, in each participant, sample data of the participant are randomly distributed to a plurality of trainers by a respective distributed system, so it is necessary to carry out strict data alignment on the sample data of each participant to ensure the correctness of training indicators. In related technologies, manual mapping is usually performed on the sample data of each participant before initiating training, which is inefficient and time-consuming, and cannot support large-scale federated learning of real-time data.

### SUMMARY

The Summary section is provided to introduce concepts in a brief form, which will be described in detail in the detailed description section below. This summary is not intended to identify key features or essential features of the claimed technical solution, nor is it intended to limit the scope of the claimed technical solution.

In a first aspect, the present disclosure provides a model training method based on federated learning, which is applied to a first trainer, the first trainer is a trainer of a first participant with a label, the method includes:
acquiring a sample intersection identifier list, in which the sample intersection identifier list includes an identifier corresponding to each sample in a sample intersection obtained after a sample alignment for the first participant with a second participant without a label;
determining a first sample subset and a sample subset identifier corresponding to the first sample subset based on the sample intersection identifier list and an original sample subset, in which the original sample subset includes a sample distributed to the first trainer, and the original sample subset includes a part of original samples of the first participant; and
transmitting the sample subset identifier to a second trainer paired with the first trainer, so as to enable the second trainer to determine a second sample subset based on the sample subset identifier and the original sample set of the second participant, in which the second trainer is a trainer of the second participant, and the first sample subset and the second sample subset are used for model training based on federated learning of the first trainer and the second trainer.

In a second aspect, the present disclosure provides a model training method based on federated learning, which is applied to a second trainer, the second trainer is a trainer of a second participant without a label, the method includes:
acquiring a sample subset identifier transmitted by a first trainer, in which the first trainer is the trainer paired with the second trainer in a first participant with a label, the sample subset identifier is determined by the first trainer based on a sample intersection identifier list and an original sample subset, the original sample subset includes a sample distributed to the first trainer, the original sample subset includes a part of original samples of the first participant, and the sample intersection identifier list includes an identifier corresponding to each sample in a sample intersection obtained after a sample alignment performed for the first participant with the second participant; and
determining a second sample subset based on the sample subset identifier and an original sample set of the second participant, in which the first sample subset and the second sample subset are used for model training based on federated learning of the first trainer and the second trainer.

In a third aspect, the present disclosure provides a model training system based on federated learning, which includes a task controller, a plurality of first trainers belonging to a first participant with a label, and a plurality of second trainers belonging to a second participant without a label, the task controller is configured to determine the first trainer and the second trainer which are paired, each of the plurality of first trainers is configured to execute the method in the first aspect; each of the plurality of second trainers is configured to execute the method in the second aspect.

In a fourth aspect, the present disclosure provides a model training apparatus based on federated learning, which is applied to a first trainer, the first trainer is a trainer of a first participant with a label, the apparatus includes:
a first acquisition module, configured to acquire a sample intersection identifier list, in which the sample intersection identifier list includes an identifier corresponding to each sample in a sample intersection obtained after a sample alignment by the first participant and a second participant without a label;
a first determination module, configured to determine a first sample subset and a sample subset identifier corresponding to the first sample subset based on the sample intersection identifier list and an original sample subset, in which the original sample subset includes a sample distributed to the first trainer, and the original sample subset includes a part of original samples of the first participant; and
a transmitting module, configured to transmit the sample subset identifier to a second trainer paired with the first trainer, so as to enable the second trainer to determine a second sample subset based on the sample subset identifier and the original sample set of the second participant, in which the second trainer is a trainer of the second participant, and the first sample subset and the second sample subset are used for model training based on federated learning of the first trainer and the second trainer.

In a fifth aspect, the present disclosure provides a model training apparatus based on federated learning, which is applied to a second trainer, the second trainer is a trainer of a second participant without a label, the apparatus includes:
a second acquisition module, configured to acquire a sample subset identifier transmitted by a first trainer, wherein the first trainer is the trainer paired with the second trainer in a first participant with a label, the sample subset identifier is determined by the first trainer based on a sample intersection identifier list and an original sample subset, the original sample subset includes a sample distributed to the first trainer, the original sample subset includes a part of sample in an original sample of the first participant, and the sample intersection identifier list comprises an identifier corresponding to each sample in a sample intersection obtained after a sample alignment performed for the first participant with the second participant; and
a second determination module, configured to determine a second sample subset based on the sample subset identifier and an original sample set of the second participant, wherein the first sample subset and the second sample subset are used for model training based on federated learning of the first trainer and the second trainer.

In a sixth aspect, the present disclosure provides a computer-readable storage medium, a computer program is stored on the computer-readable storage medium, and the computer program, and the computer program, when executed by a processing apparatus, cause the processing apparatus to implement the method according to any one of the first aspect and the second aspect.

In a seventh aspect, the present disclosure provides an electronic device, which includes:
a storage apparatus, thereon a computer program is stored; and
a processing apparatus, configured to execute the computer program stored on the storage apparatus to implement the method according to any one of the first aspect and the second aspect.

In an eighth aspect, the present disclosure provides a computer program product, which includes a computer program, in which the computer program, when executed by a processor, cause the processor to implement the method according to any one of the first aspect and the second aspect.

Other features and advantages of the present disclosure will be described in detail in the detailed description section that follows.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale. In the drawings:

FIG. 1 is a schematic diagram of a vertical federated learning processing illustrated according to an exemplary embodiment of the present disclosure;

FIG. 2 is a schematic diagram of sample data distribution illustrated according to an exemplary embodiment of the present disclosure;

FIG. 3 is a schematic diagram of a “virtual” training sample set illustrated according to an exemplary embodiment of the present disclosure;

FIG. 4 is a flowchart of a model training method based on federated learning illustrated according to an exemplary embodiment of the present disclosure;

FIG. 5 is a schematic diagram of a model training method based on federated learning illustrated according to an exemplary embodiment of the present disclosure;

FIG. 6 is a schematic diagram of a process of determining a cache sample set illustrated according to an exemplary embodiment of the present disclosure;

FIG. 7 is a schematic diagram of a model training system based on federated learning illustrated according to an exemplary embodiment of the present disclosure;

FIG. 8 is a flowchart of a model training method based on federated learning illustrated according to an exemplary embodiment of the present disclosure;

FIG. 9 is a flowchart of a model training method based on federated learning illustrated according to an exemplary embodiment of the present disclosure;

FIG. 10 is a structure block diagram of a model training apparatus based on federated learning illustrated according to an exemplary embodiment of the present disclosure;

FIG. 11 is a structure block diagram of a model training apparatus based on federated learning illustrated according to an exemplary embodiment of the present disclosure; and

FIG. 12 is a structure schematic diagram of an electronic device illustrated according to an exemplary embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

Names of messages or information exchanged among multiple devices in the embodiment of the present disclosure are only used for illustrative purposes, and are not used to limit the scope of these messages or information.

It can be understood that before using the technical solutions disclosed in various embodiments of this disclosure, users should be informed of the types, scope of use, use scenarios, etc. of personal information involved in this disclosure in an appropriate way according to relevant laws and regulations and be authorized by users.

For example, in response to receiving the user's active request, prompt information is sent to the user to clearly remind the user that the operation requested by the user will require obtaining and using the user's personal information. Therefore, the user can independently choose whether to provide personal information to software or hardware such as electronic devices, applications, servers or storage media that perform the operation of the technical scheme of the present disclosure according to the prompt information.

As an optional but non-limiting implementation, in response to receiving the user's active request, the way to send the prompt information to the user can be, for example, a pop-up window, in which the prompt information can be presented in text. In addition, the pop-up window can also carry a selection control for the user to choose “agree” or “disagree” to provide personal information to the electronic device.

It can be understood that the above process of notifying and obtaining user authorization is only schematic, and does not limit the implementation of this disclosure. Other ways to meet relevant laws and regulations can also be applied to the implementation of this disclosure.

At the same time, it can be understood that the data involved in this technical scheme (including but not limited to the data itself, data acquisition or use) should comply with the requirements of corresponding laws, regulations and relevant regulations.

Due to different sample data set distribution conditions of a plurality of participants, federated learning can be divided into three types, including horizontal federated learning, vertical federated learning and federated transfer learning. The vertical federated learning refers to a scenario with more sample overlapping and less feature overlapping among the participants, for example, a Company A and a Company B have a batch of same user groups, but the Company A and the Company B respectively have different service features of the user groups.

As illustrated in FIG. 1, in the vertical federated learning, data are generally divided according to features, each participant has respective feature data, and the feature data of each participant will be aligned according to a same ID identifier during training. By taking two participants performing vertical federated learning as an example, a Party A provides a data Label, the Party A and a Party B train respective Bottom models, and the Party A interactively links forward Embedding (Embedding vector) and backward gradient information of the Party B based on a model training interaction layer, so as to complete Top model training.

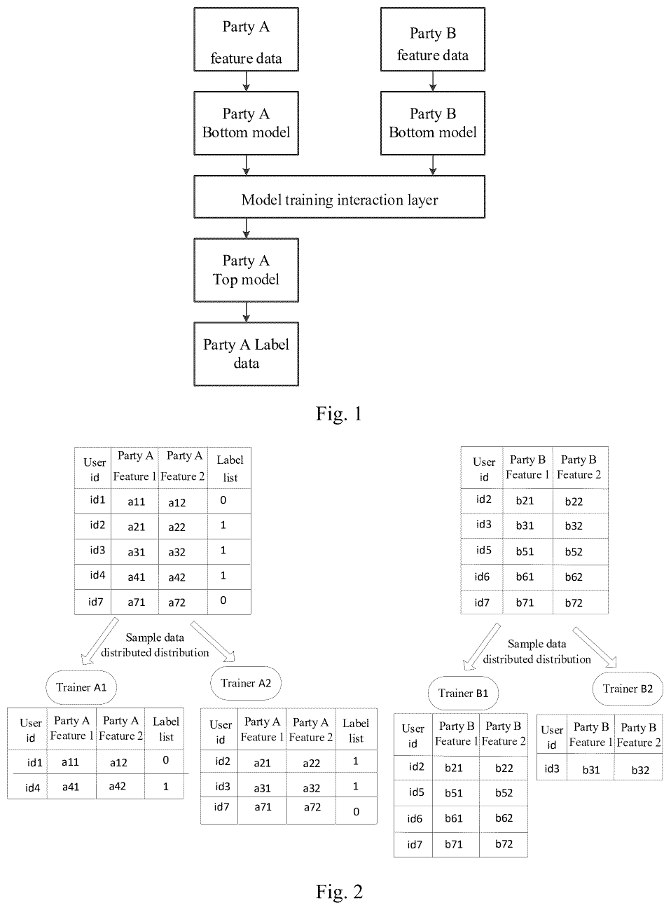

By taking the two participants performing vertical federated learning as an example again, for a data parallel type multi-machine model training scenario, for example, each of the A Party and the Party B includes two trainers, as illustrated in FIG. 2, sample data of the A party are randomly distributed to the two trainers by a respective distributed system, the first trainer has a sample set corresponding to id1 and id4, and the second trainer has sample sets corresponding to id2, id3 and id7. Correspondingly, the sample data of the Party B are also randomly distributed to the two trainers by the respective distributed system, the first trainer has a sample set corresponding to id2, id5, id6 and id7, and the second trainer has a sample set corresponding to id3.

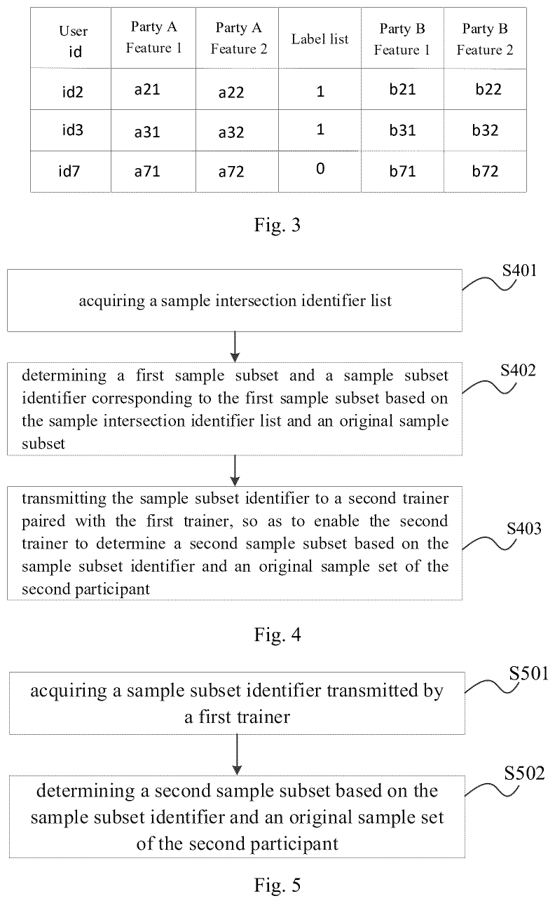

According to the correctness and security requirements of federated learning, a common id intersection is obtained based on a private set intersection (PSI), the sample set of the two parties logically form a “virtual” training sample set as illustrated in FIG. 3, namely, the virtual training sample set is formed by corresponding samples in the sample intersection of the two parties, and sample features and labels of each party need to be strictly aligned according to ids.

In related technology, it is mainly to limit each participant to sequentially process all samples with a single trainer, the federated learning is carried out on a single machine to complete the model training, the multi-machine concurrency capability is limited, and it is difficult to realize large-scale distributed concurrent training of mass sample data. Or, manual mapping is usually performed on the sample data of each participant before initiating training, which is inefficient and time-consuming, and cannot support large-scale federated learning of real-time data. In other words, the vertical federated learning system is limited by its architecture, so it generally supports data magnitude within 1 billion level, and has limitation on the supported model scale, and a large-scale vertical federated learning system needs large-scale distributed training architectures that support huge training sample size (such as 10 billion level) and continuous streaming (such as 1 billion level increase every day), a training framework adaptive to a parameter server, etc.

In view of this, the present disclosure provides a model training method, system and apparatus based on federated learning, and an electronic device to solve the above technical problems. It is to be noted that the model training method based on federated learning provided by the present disclosure can be suitable for a large-scale vertical federated learning scenario, each participant can be of a distributed structure, that is, each participant includes a plurality of trainers.

The embodiments of the present disclosure are further described below in conjunction with the accompanying drawings. For easy description, the embodiments are illustrated by model training based on two-party vertical federated learning of the Party A and the Party B. In practical application, it can be applied to the model training based on horizontal federated learning of any multiple parties.

The embodiments of the present disclosure are further explained below in conjunction with the accompanying drawings.

FIG. 4 is a flowchart of a model training method based on federated learning illustrated according to an exemplary embodiment of the present disclosure. The method is applied to a first trainer which is a trainer of a first participant with a label; and with reference to FIG. 4, the method includes:
S401: acquiring a sample intersection identifier list.

The sample intersection identifier list includes an identifier corresponding to each sample in a sample intersection obtained after a sample alignment by the first participant and a second participant without a label, such as the sample id of the “virtual” training sample set as illustrated in FIG. 3, in which, the sample intersection can be obtained based on the private set intersection.
S402: determining a first sample subset and a sample subset identifier corresponding to the first sample subset based on the sample intersection identifier list and an original sample subset.

The original sample subset includes a sample distributed to the first trainer, and the original sample subset includes a part of original samples of the first participant, such as the sample set distributed by the participant to single trainer as illustrated in FIG. 2, and the sample subset identifier may be the id of the sample, which is not limited in the present disclosure.

In a possible embodiment, determining the first sample subset based on the sample intersection identifier list and the original sample subset may include: in the original sample subset, determining the sample with a sample identifier belonging to the sample intersection identifier list as being included in the first sample subset.

Exemplarily, by taking the sample data illustrated in FIG. 2 and FIG. 3 as an example, the sample intersection identification list includes sample ids of the “virtual” training sample set illustrated in FIG. 3, and the first sample subset determined by the trainer A2 refers to sample data corresponding to id2, id3 and id7.

It is to be noted that the id in the sample subset identifier transmitted to the second trainer by the first trainer is obtained after filtering based on the private set intersection, so that the id out of the intersection of the two parties does not exist, feature fields of the sample data are not involved, and the security of federated learning is not influenced.
S403: transmitting the sample subset identifier to a second trainer paired with the first trainer, so as to enable the second trainer to determine a second sample subset based on the sample subset identifier and an original sample set of the second participant.

The second trainer is a trainer of the second participant, and the first sample subset and the second sample subset are used for model training based on federated learning of the first trainer and the second trainer.

Exemplarily, by taking the first trainer as a trainer A2, and the second trainer as a trainer B1 as an example, in a case that the sample subset identifiers determined by the trainer A2 are id2, id3 and id7, the trainer B1 can screen out sample data corresponding to the id2, id3 and id7 from the original sample set of a Party B, and the sample data corresponding to the id2, id3 and id7 are treated as the second sample subset.

That is, the first trainer determines the first sample subset based on the sample intersection identifier list and the respective distributed original sample subset, and the second trainer does not use the respective distributed original sample subset, but re-determines the second sample subset based on the sample subset identifier corresponding to the first sample subset determined by the first trainer. Therefore, the first trainer and the second trainer participating in model training based on federated learning realize dynamic sample alignment, and the sample alignment efficiency is improved. Moreover, it is suitable for large-scale distributed training architectures that support huge training sample size (such as 10 million level) and continuous streaming (such as 1 billion level increase every day), a training framework adaptive to a parameter server, etc.

By adopting the above method, the first trainer firstly acquires the sample intersection identifier list obtained by the first sample alignment carried out based on the original sample set of each participant, then determines the first sample subset based on the sample intersection identifier list and a part of respective distributed samples, and transmits the sample subset identifier corresponding to the first sample subset to the paired second trainer, then the second trainer determines the corresponding second sample subset, thus realizing second sample alignment after the trainers are paired. Based on the sample alignment in the two stages, automatic alignment of the sample data of the trainer of each participant is realized, the sample alignment efficiency and the efficiency of the model training based on federated learning are improved, and therefore, the large-scale model training based on federated learning on real-time data can be supported.

In a possible embodiment, the method further includes: after the first trainer is started, transmitting a registration request to a task controller, so as to enable the task controller to determine the second trainer paired with the first trainer in response to the registration request.

Exemplarily, after the first trainer is started, the registration request can be transmitted to the task controller, the task controller is configured to pair the trainer of each participant participating in the model training based on federated learning, and the task controller can be arranged in a safe and neutral server, such as a coordinator in federated learning.

In a possible embodiment, the method further includes: transmitting a polling request for a pairing state to the task controller, so as to enable the task controller to transmit, in response to the polling request, a trainer identifier of the second trainer to the first trainer after determining the second trainer paired with the first trainer. Transmitting the sample subset identifier to the second trainer paired with the first trainer may include: transmitting the sample subset identifier to the second trainer corresponding to the trainer identifier.

Exemplarily, the first trainer transmits the registration request to the task controller, and can transmit the polling request for the pairing state to the task controller at a certain time interval. In response to that the task controller does not determine the second trainer paired with the first trainer, there is no response to the polling request. In response to that the task controller determines the second trainer paired with the first trainer, the trainer identifier of the second trainer is transmitted to the first trainer, thus the first trainer can perform data interaction with the second trainer according to the trainer identifier, and then the cooperative training of the first trainer and the second trainer is realized.

In a possible embodiment, the method further includes: in a case that the polling request is transmitted to the task controller, and the trainer identifier transmitted by the task controller is not received within a first preset duration, or, in a case that the sample subset identifier is transmitted to the second trainer corresponding to the trainer identifier, and a feedback message transmitted by the second trainer is not received within a second preset duration, transmitting a new registration request to the task controller, so as to enable the task controller to re-determine the second trainer paired with the first trainer in response to the new registration request.

Exemplarily, after the registration request is transmitted to the task controller, in response to that the first trainer does not receive the trainer identifier transmitted by the task controller within the first preset duration, there may be an abnormality in pairing, or the task manager does not receive the registration request, a new registration request can be transmitted to the task controller, so as to enable the task controller to perform trainer pairing again. Or, the first trainer can be restarted to transmit a new registration request to the task controller, which is not limited in the present disclosure.

Exemplarily, in response to abnormal data interaction between the first trainer and the second trainer, for example, in response to that the second trainer does not respond to a message transmitted by the first trainer within the second preset duration, the second trainer may be abnormal, for example, exit the model training based on federated learning due to faults, the first trainer can also transmit a new registration request to the task controller again, so that the task controller can perform trainer pairing again.

The first preset duration and the second preset duration can be equal or not equal, which is not limited in the present disclosure. Therefore, in the process that each trainer polls and requests the current pairing state and the trainers having a pairing relationship execute a model training task, by setting the timeout time, the trainers can be paired again in response to normal pairing or the trainer exiting due to faults, and thus flexible pairing of the trainers of all parties is achieved.

In a possible embodiment, the first trainer and the second trainer which are paired are determined through the task controller by: in response to both a first to-be-paired list and a second to-be-paired list being non-null, randomly selecting a first identifier from the first to-be-paired list, randomly selecting a second identifier from the second to-be-paired list, and respectively taking a trainer corresponding to the first identifier and a trainer corresponding to the second identifier as the first trainer and the second trainer which are paired; in which the first to-be-paired list is used for storing an identifier of the trainer of the first participant that transmits the registration request, and the second to-be-paired list is used for storing an identifier of the trainer of the second participant that transmits the registration request.

Exemplarily, in response to that trainers A1 and A2 of the first participant transmit the registration request to the task controller, trainer identifiers A1 and A2 will be stored in the first to-be-paired list, and correspondingly, in response to that trainers B1 and B2 of the second participant transmit the registration request to the task controller, the trainer identifiers B1 and B2 will be stored in the second to-be-paired list. The task controller randomly selects one trainer identifier from the first to-be-paired list and the second to-be-paired list respectively, for example, it selects A1 is from the first to-be-paired list, and selects B1 from the second to-be-paired list, and a pairing relationship is marked.

Or, by taking the trainer A1 of the first participant as an example, the task controller can also inquire whether the to-be-paired trainer of the second participant is in the second to-be-paired list or not in response to receiving the registration request transmitted by the trainer A1; and in response to yes, one trainer is randomly selected as the trainer paired with the trainer A1, otherwise, the trainer identifier of the trainer A1 is stored into the first to-be-paired list, and pairing will be performed after the trainer of the second participant transmits the registration request to the task controller. Specifically, the pairing process can be determined according to requirements, which is not limited in the present disclosure.

It is to be noted that dynamic pairing of the trainers can be implemented by introducing the task controller into the federated learning system, information maintained by the task controller only involves the training task name, the trainer identifier and other information of each participant, and any feature field of the sample data of each participant cannot be known, so that the security of federated learning cannot be affected.

FIG. 5 is a schematic diagram of a model training method based on federated learning illustrated according to an exemplary embodiment of the present disclosure. The method is applied to a second trainer which is a trainer of a second participant without a label, with reference to FIG. 5, the method includes:
S501: acquiring a sample subset identifier transmitted by a first trainer.

The first trainer is a trainer paired with the second trainer in a first participant with a label, the sample subset identifier is determined by the first trainer based on a sample intersection identifier list and an original sample subset, the original sample subset includes a sample distributed to the first trainer, the original sample subset includes a part of original samples of the first participant, and the sample intersection identifier list includes an identifier corresponding to each sample in a sample intersection obtained after a sample alignment performed for the first participant with the second participant.
S502: determining a second sample subset based on the sample subset identifier and an original sample set of the second participant.

The first sample subset and the second sample subset are used for model training based on federated learning of the first trainer and the second trainer.

According to the above method, the second trainer can determine the second sample subset corresponding to the paired second trainer according to the sample subset identifier corresponding to the first sample subset after determining the first sample subset by the first trainer of the first participant with the label; and based on the sample alignment in the two stages, automatic alignment of the sample data of the trainer of each participant is realized, the sample alignment efficiency and the efficiency of the model training based on federated learning are improved, and therefore, the large-scale model training based on federated learning on real-time data can be supported.

In a possible embodiment, the method further includes: acquiring a cached sample set, in which, the cached sample set includes the sample with a sample identifier belonging to the sample intersection identifier list in the original sample set of the second participant. Determining the second sample subset based on the sample subset identifier and the original sample set of the second participant may include: in the cached sample set, determining the sample with the sample identifier belonging to the sample subset identifier as being comprised in the second sample subset.

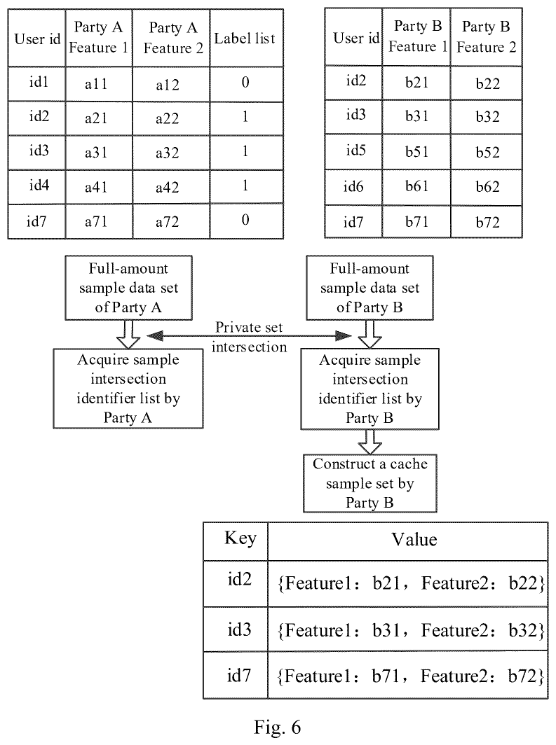

Exemplarily, with reference to FIG. 6, the Party A and the Party B obtain the sample intersection identifier list based on the private set intersection and full-amount sample data sets (namely original sample sets) of the two parties, and after the Party B acquires the sample intersection identifier list, respective full-amount sample data sets can be screened based on the sample intersection identifier list to obtain the cached sample set corresponding to the sample intersection identifier list. Therefore, in response to that the second trainer constructs the second sample subset, the cached sample set can be screened based on the sample subset identifier, and compared with screening the full-amount sample data set, the efficiency of constructing the second sample subset by the second trainer can be improved.

In a possible embodiment, each sample in the cache sample set is stored in a form of key-value pair, in which, the sample identifier of the sample is a keyword, and the sample feature of the sample is a value corresponding to the keyword.

Exemplarily, with reference to FIG. 6, each sample in the cache sample set can be stored in the form of key-value pair, the sample identifier of the sample is Key, and the sample feature of the sample is Value corresponding to Key; and the sample is stored in the form of key-value pair, so that the second trainer can conveniently perform screening based on the sample identifier, and the efficiency of constructing the second sample subset by the second trainer is further improved.

It is to be noted that a storage module of the cache sample set is not limited in the present disclosure, it can be an internal memory type storage module such as a KV cache and redis, or a database system such as MySQL, and it can be specifically set according to requirements.

In a possible embodiment, the method further includes: after the second trainer is started, transmitting a registration request to a task controller, so as to enable the task controller to determine the first trainer paired with the second trainer in response to the registration request.

Exemplarily, after the second trainer is started, the registration request can be transmitted to the task controller, the task controller is configured to pair the trainer of each participant participating in federated learning, the specific pairing process is described above, and the present disclosure will not be listed here.

In a possible embodiment, the method further includes: transmitting a polling request for a pairing state to the task controller, so as to enable the task controller to transmit, in response to the polling request, a trainer identifier of the first trainer to the second trainer after determining the first trainer paired with the second trainer; and in response to receiving the trainer identifier of the first trainer, blocking to wait for the sample subset identifier transmitted by the first trainer.

Exemplarily, the second trainer transmits the registration request to the task controller, and can transmit the polling request for the pairing state to the task controller at a certain time interval. In response to that the task controller does not determine the first trainer paired with the second trainer, there is no response to the polling request. In response to that the task controller determines the first trainer paired with the second trainer, the trainer identifier of the first trainer will be transmitted to the second trainer. After the second trainer receives the trainer identifier of the first trainer, it will block to wait for the sample subset identifier transmitted by the first sensor, and after the first trainer can perform data interaction with the second trainer according to the trainer identifier, the cooperative training of the first trainer and the second trainer is realized.

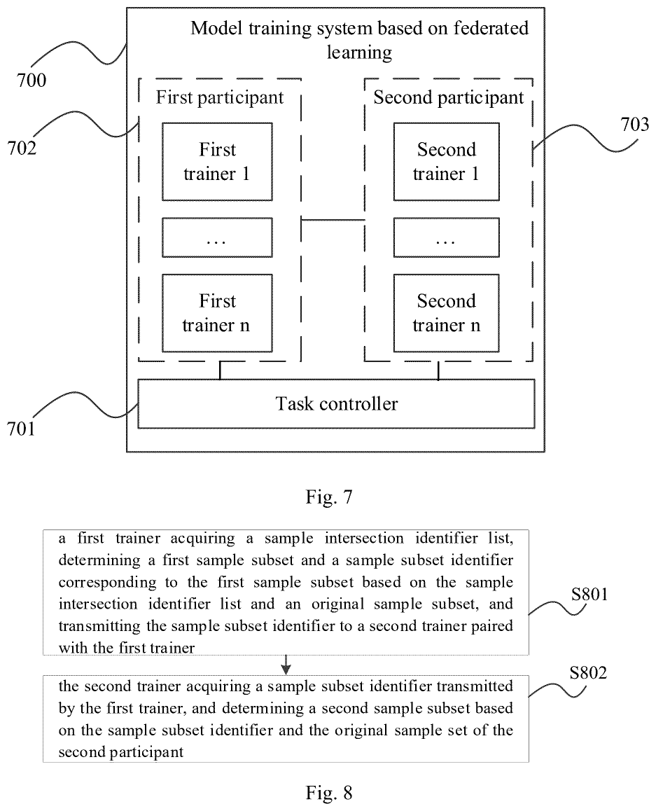

FIG. 7 illustrates a framework of a model training system based on federated learning illustrated according to an exemplary embodiment of the present disclosure. With reference to FIG. 7, the model training system 700 based on federated learning 700 includes a task controller 701, a plurality of first trainers belonging to a first participant 702 with a label, and a plurality of second trainers belonging to a second participant 703 without a label; the first trainer is configured to execute the above method applied to the first trainer; the second trainer is configured to execute the above method applied to the second trainer; and the task controller 701 is configured to determine the first trainer and the second trainer which are paired.

By adopting the system, the first trainer can determine the first sample subset based on the sample intersection identifier list and a part of distributed sample, and the second trainer can determine the corresponding second sample subset based on the sample subset identifier corresponding to the first sample subset. Based on the sample alignment in the two stages, automatic alignment of the sample data of the trainer of each participant is realized, the sample alignment efficiency and the efficiency of the model training based on federated learning are improved, and therefore, the large-scale model training based on federated learning on real-time data can be supported.

The following takes two participants participating in the model training based on federated learning as an example to illustrate the embodiments of the interactive process of the model training method based on federated learning provided by the present disclosure.

FIG. 8 is a flowchart of a model training method based on federated learning illustrated according to an exemplary embodiment of the present disclosure. With reference to FIG. 8, the method includes:
S801: a first trainer acquiring a sample intersection identifier list, determining a first sample subset and a sample subset identifier corresponding to the first sample subset based on the sample intersection identifier list and an original sample subset, and transmitting the sample subset identifier to a second trainer paired with the first trainer.

The first trainer is a trainer of a first participant with a label; the second trainer is a trainer of a second participant without a label; the sample intersection identifier list includes an identifier corresponding to each sample in the sample intersection obtained after sample alignment by the first participant and a second participant without a label; and the original sample subset includes a sample distributed to the first trainer, and the original sample subset includes a part of original samples of the first participant.
S802: the second trainer acquiring a sample subset identifier transmitted by the first trainer, and determining a second sample subset based on the sample subset identifier and the original sample set of the second participant.

The first sample subset and the second sample subset are used for model training based on federated learning of the first trainer and the second trainer.

By adopting the method, the sample intersection identifier obtained by first sample alignment carried out based on the original sample set of each participant is acquired, then the first trainer can determine the first sample subset based on the sample intersection identifier list and a part of distributed samples, and the second trainer can determine the corresponding second sample subset based on the sample subset identifier corresponding the first sample subset, thus realizing second sample alignment after the trainers are paired. Based on the sample alignment in the two stages, automatic alignment of the sample data of the trainer of each participant is realized, the sample alignment efficiency and the efficiency of the model training based on federated learning are improved, and therefore, the large-scale model training based on federated learning on real-time data can be supported.

Exemplarily, by taking the Party A and the Party B carrying out model training based on federated learning as an example again, offline sample data preprocessing preparation is carried out firstly. The two parties export the id set corresponding to the respective original sample set offline, and obtain an intersection id, namely, the sample intersection identifier list, based on the private set intersection, thus realizing the first sample alignment. Then the Party B which does not provide the label determines a cache sample set which takes the sample id as a main key based on the intersection id and respective original sample set, and the data preprocessing process illustrated in FIG. 6 can be referred to, which will not be listed here.

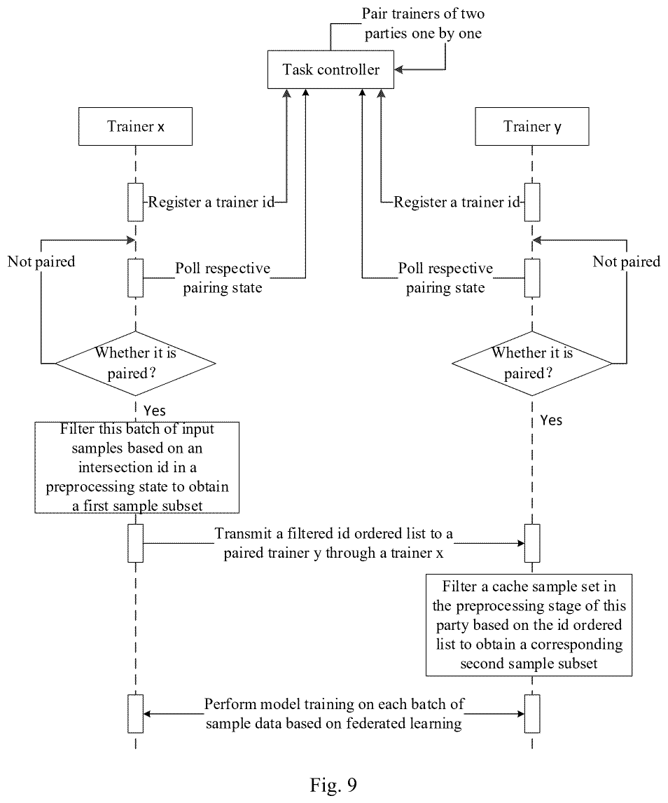

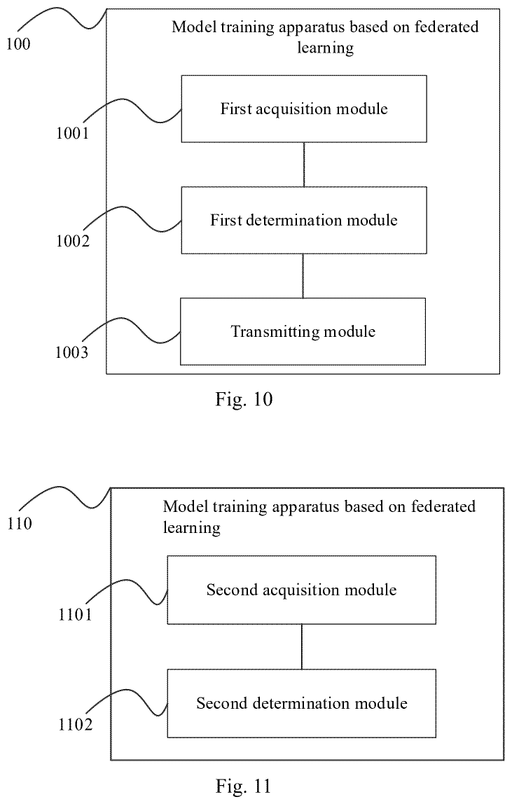

Then, the two parties respectively start the same number of trainers to carry out model training based on distributed federated learning. After a certain trainer of any party is started, the trainer is registered in the task controller, and the registration content is the trainer id of the trainer, such as a trainer x of the Party A and a trainer y of the Party B illustrated in FIG. 9. After the task controller receives the registration request of a party, the trainer will be put into respective to-be-paired list; and in response to that the to-be-paired lists of the two parties are non-null, one trainer id will be randomly taken out, a pairing relationship will be marked, namely, the trainers of the two parties are paired one by one, thus realizing dynamic pairing of the trainers, for example, the trainer x and the trainer y are treated as a group of paired trainers. After registration is completed, each trainer can poll the task controller whether it is paired or not, and in response to that the task controller identifies that the trainer is paired, the trainer id of the opposite paired trainer will be notified to the trainer.

By taking the trainer x and the trainer y treated as a group of paired trainers as an example again, with reference to FIG. 9, after the trainer x acquires the id of the paired trainer y, the distributed original sample subset of the trainer x is filtered based on the intersection id, the feature and label of the sample with the id reserved in the intersection enter the Bottom model of this party, moreover, an id ordered list of the sample is recorded, namely the sample subset identifier, and the id ordered list is transmitted to the paired trainer y. After the trainer y acquires the id of the paired trainer x of the opposite party, it will block to wait for the trainer x to transmit the id ordered list; and after the id ordered list is received, corresponding sample in the cache sample set of the B Party is inquired based on the id ordered list, so as to obtain the second sample subset, and the second sample subset enters the Bottom model of this party as the sample of this party according to the same sequence, thus realizing second sample alignment after the trainers are paired. Each group of paired trainers of the two parties performs forward data interaction and reverse gradient propagation of model training based on a federated learning algorithm to complete the training process.

It is to be noted that in the present disclosure, it does not depend on manual sample alignment, but can carry out regular incremental preprocessing and real-time online multi-party trainer matching, thus, continuous training based on single federated learning for real-time new sample data can be supported. The participant in federated learning can start any number of trainers to participate in training in parallel at the same time, and it is not needed to process mass sample data on single trainer in series, so the overall training efficiency is improved.

In addition, considering that the trainer x may exit from federated learning because of pairing failure, the original sample subset is filtered based on the intersection id after pairing is successful. However, because it is needed to consume a certain duration in the pairing of the task controller, the trainer x can filter the original sample subset based on the intersection id before pairing, and then directly transmit the id ordered list to the trainer y after acquiring the id of the paired trainer y. It specifically can be set according to requirements, which will not be listed here.

By adopting the method, large-scale distributed federated learning is supported through two-stage sample alignment and dynamic pairing of multi-party distributed trainers. Each participant can start a plurality of trainers to carry out model training based on federated learning at the same time, thus the model training efficiency is improved, and the sample data size and the model parameter scale which can be supported by the federated learning system are expanded. By dividing two stages of data preprocessing and real-time online training, a large-scale and transversely-expandable multi-party fine sample alignment mechanism is realized. And dynamic pairing management of the multi-party distributed trainers is realized through the safe and neutral task controller, so that multi-party efficient and stable data parallel training is supported.

Based on the same concept, an embodiment of the present disclosure further provides a model training apparatus based on federated learning, the apparatus is applied to a first trainer which is a trainer of a first participant with a label; and with reference to FIG. 10, the model training apparatus 100 based on federated learning includes:
a first acquisition module 1001, configured to acquire a sample intersection identifier list, in which the sample intersection identifier list comprises an identifier corresponding to each sample in a sample intersection obtained after a sample alignment for the first participant with a second participant without a label;
a first determination module 1002, configured to determine a first sample subset and a sample subset identifier corresponding to the first sample subset based on the sample intersection identifier list and an original sample subset, wherein the original sample subset includes a sample distributed to the first trainer, and the original sample subset includes a part of original samples of the first participant; and
a transmitting module 1003, configured to transmit the sample subset identifier to a second trainer paired with the first trainer, so as to enable the second trainer to determine a second sample subset based on the sample subset identifier and an original sample set of the second participant, in which the second trainer is a trainer of the second participant, and the first sample subset and the second sample subset are used for model training based on federated learning of the first trainer and the second trainer.

Optionally, the first determination module 1002 is configured to:
in the original sample subset, determine a sample with a sample identifier belonging to the sample intersection identifier list as being included in the first sample subset.

Optionally, the model training apparatus 100 based on federated learning further includes:
a first registration module, configured to: after the first trainer is started, transmit a registration request to a task controller, so as to enable the task controller to determine the second trainer paired with the first trainer in response to the registration request.

Optionally, the model training apparatus 100 based on federated learning further includes:
a first polling module, configured to transmit a polling request for a pairing state to the task controller, so as to enable the task controller to transmit, in response to the polling request, a trainer identifier of the second trainer to the first trainer after determining the second trainer paired with the first trainer.

The transmitting module 1003 is configured to transmit the sample subset identifier to the second trainer corresponding to the trainer identifier.

Optionally, the first trainer and the second trainer which are paired are determined through the task controller by:
in response to both a first to-be-paired list and a second to-be-paired list being non-null, randomly selecting a first identifier from the first to-be-paired list, randomly selecting a second identifier from the second to-be-paired list, and respectively taking a trainer corresponding to the first identifier and a trainer corresponding to the second identifier as the first trainer and the second trainer which are paired; and
the first to-be-paired list is used for storing an identifier of the trainer of the first participant that transmits the registration request, and the second to-be-paired list is used for storing an identifier of the trainer of the second participant that transmits the registration request.

Optionally, the model training apparatus 100 based on federated learning further includes:
a timeout module, configured to: in a case that the polling request is transmitted to the task controller, and the trainer identifier transmitted by the task controller is not received within a first preset duration, or, in a case that the sample subset identifier is transmitted to the second trainer corresponding to the trainer identifier, and a feedback message transmitted by the second trainer is not received within a second preset duration, transmit a new registration request to the task controller, so as to enable the task controller to re-determine the second trainer paired with the first trainer in response to the new registration request.

Based on the same concept, an embodiment of the present disclosure further provides a model training apparatus based on federated learning, the apparatus is applied to a second trainer which is a trainer of a second participant without a label, with reference to FIG. 11, the model training apparatus 110 based on federated learning includes:
a second acquisition module 1101, configured to acquire a sample subset identifier transmitted by a first trainer, in which, the first trainer is a trainer paired with the second trainer in a first participant with a label, the sample subset identifier is determined by the first trainer based on a sample intersection identifier list and an original sample subset, the original sample subset includes a sample distributed to the first trainer, the original sample subset includes a part of original samples of the first participant, and the sample intersection identifier list includes an identifier corresponding to each sample in a sample intersection obtained after a sample alignment performed for the first participant with the second participant;
a second determination module 1102, configured to determine a second sample subset based on the sample subset identifier and an original sample set of the second participant, in which, the first sample subset and the second sample subset are used for model training based on federated learning of the first trainer and the second trainer.

Optionally, the model training apparatus 110 based on federated learning further includes:
a cache module, configured to: acquire a cached sample set, in which, the cached sample set includes a sample with a sample identifier belonging to the sample intersection identifier list in the original sample set of the second participant; and
the second determination module 1102 is configured to:
in the cached sample set, determine a sample with a sample identifier belonging to the sample subset identifier as being comprised in the second sample subset.

Optionally, each sample in the cached sample set is stored in a form of a key-value pair, the sample identifier of the sample is a keyword, and the sample feature of the sample is a value corresponding to the keyword.

Optionally, the model training apparatus 110 based on federated learning further includes:
a second registration module, configured to: after the second trainer is started, transmit a registration request to a task controller, so as to enable the task controller to determine the first trainer paired with the second trainer in response to the registration request.

Optionally, the model training apparatus 110 based on federated learning further includes:
a second polling module, configured to transmit a polling request for a pairing state to the task controller, so as to enable the task controller to transmit, in response to the polling request, a trainer identifier of the first trainer to the second trainer after determining the first trainer paired with the second trainer; and
a waiting module, configured to: in response to receiving the trainer identifier of the first trainer, block to wait for the sample subset identifier transmitted by the first trainer.

The specific operation execution mode of each module of the apparatus in the above embodiments has been described in detail in relevant embodiment of the method, and will not be listed here.

Based on the same concept, an embodiment of the present disclosure further provides a computer-readable storage medium, a computer program is stored on the computer-readable storage medium, and the computer program, when executed by a processing apparatus, implements the model training method based on federated learning provided by any embodiment.

Based on the same concept, an embodiment of the present disclosure further provides an electronic device, which can include:
a storage apparatus, on which a computer program is stored; and
a processing apparatus, configured to execute the computer program stored on the storage apparatus to implement the model training method based on federated learning provided by any one of the above embodiments.

Based on the same concept, an embodiment of the present disclosure provides a computer program product, which includes a computer program, and the computer program, when executed by a processor, cause the processor to implement the model training method based on federated learning provided by any one of the above embodiments.

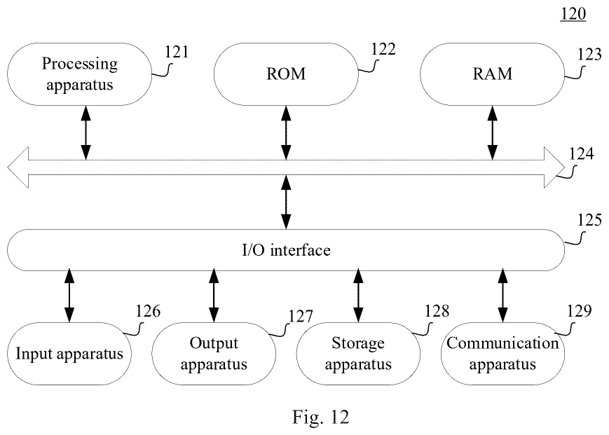

Reference is made to FIG. 12, which shows a structural schematic diagram of an electronic device (such as a terminal device or a server) 120 suitable for implementing the embodiment of the present disclosure. A terminal device in the embodiment of the present disclosure may include but not limited to a mobile terminal such as a mobile phone, a notebook computer, a digital radio broadcasting receiver, a personal digital assistant (PDA), a portable android device (PAD), a portable multimedia player (PMP), a vehicle terminal (such as a vehicle navigation terminal), and a fixed terminal such as a digital television (TV) and a desktop computer. The electronic device shown in FIG. 12 is only an example and should not impose any limitations on the functions and usage scopes of the embodiments of the present disclosure.

As shown in FIG. 12, the electronic device 120 may include a processing apparatus (such as a central processing unit, a graphics processor, and the like) 121, which may execute various appropriate actions and processes according to a program stored in a read-only memory (ROM) 122 or a program loaded from a storage apparatus 128 to a random-access memory (RAM) 123. In the RAM 123, various programs and data required for operations of the electronic device 120 are further stored. The processing apparatus 121, the ROM 122, and the RAM 123 are connected to each other by a bus 124. An input/output (I/O) interface 125 is also connected to the bus 124.

Generally, the following apparatuses may be connected to the I/O interface 125: an input apparatus 126 such as a touch screen, a touch pad, a keyboard, a mouse, a camera, a microphone, an accelerometer, a gyroscope, etc.; an output apparatus 127 such as a liquid crystal display (LCD), a loudspeaker, a vibrator, etc.; a storage apparatus 128 such as a magnetic tape, and a hard disk, etc.; and a communication apparatus 129. The communication apparatus 129 may allow the electronic device 120 to perform wireless or wire communication with other devices to exchange data. Although FIG. 12 shows the electronic device 120 with various apparatuses, it should be understood that it is not required to implement or possess all the apparatuses shown. It may implement alternatively or possess the more or less apparatuses.

According to the embodiment of the present disclosure, the process described above with reference to the flowcharts may be achieved as a computer software program. For example, an embodiment of the present disclosure includes a computer program product, the computer program product includes a computer program loaded on a non-transitory computer-readable medium, and the computer program contains program codes for executing the method shown in the flowcharts. In such an embodiment, the computer program may be downloaded and installed from the network by the communication apparatus 129, or installed from the storage apparatus 128, or installed from ROM 122. When the computer program is executed by the processing apparatus 121, the above functions in the method in the embodiments of the present disclosure are executed.

It should be noted that the computer-readable medium mentioned above in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, device or device, or any combination thereof. More specific examples of the computer-readable storage medium may include, but not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium containing or storing a program that may be used by or in combination with an instruction execution system, device or device. In the present disclosure, the computer-readable signal medium may include a data signal propagated in a baseband or as a part of a carrier wave, in which computer-readable program codes are carried. This propagated data signal may take multiple forms, including but not limited to an electromagnetic signal, an optical signal or any suitable combination of the above. The computer-readable signal medium may also be any computer-readable medium other than the computer-readable storage medium, and may send, propagate or transmit a program used by or in combination with an instruction execution system, device or device. The program codes contained on the computer-readable medium may be transmitted by any suitable medium, including but not limited to: an electric wire, a fiber-optic cable, radio frequency (RF) and the like, or any suitable combination of the above.

In some implementation methods, any currently known or future developed network protocol such as a hypertext transfer protocol (HTTP) can be used to communicate, and digital data in any form or medium (for example, a communication network) may be communicated and interconnected with. Examples of the communication network include a local area network (“LAN”), a wide area network (“WAN”), the Internet work (for example, the Internet) and an end-to-end network (for example, an ad hoc end-to-end network), as well as any currently known or to be researched and developed in the future.

The above computer-readable medium may be contained in the above electronic device; and it may also exist separately without being assembled into the electronic device.

The above computer-readable medium carries one or more programs, and when the above one or more programs are executed by the electronic device, the electronic device: acquiring a sample intersection identifier list, in which the sample intersection identifier list comprises an identifier corresponding to each sample in a sample intersection obtained after a sample alignment for the first participant with a second participant without a label; determining a first sample subset and a sample subset identifier corresponding to the first sample subset based on the sample intersection identifier list and an original sample subset, in which the original sample subset includes a sample distributed to the first trainer, and the original sample subset includes a part of original samples of the first participant; and transmitting the sample subset identifier to a second trainer paired with the first trainer, so as to enable the second trainer to determine a second sample subset based on the sample subset identifier and an original sample set of the second participant, in which the second trainer is a trainer of the second participant, and the first sample subset and the second sample subset are used for model training based on federated learning of the first trainer and the second trainer.

Or, the above computer-readable medium carries one or more programs, and when the above one or more programs are executed by the electronic device, the electronic device: acquiring a sample subset identifier transmitted by a first trainer, in which the first trainer is a trainer paired with the second trainer in a first participant with a label, the sample subset identifier is determined by the first trainer based on a sample intersection identifier list and an original sample subset, the original sample subset includes a sample distributed to the first trainer, the original sample subset includes a part of original samples of the first participant, and the sample intersection identifier list comprises an identifier corresponding to each sample in a sample intersection obtained after a sample alignment performed for the first participant with the second participant; and determining a second sample subset based on the sample subset identifier and an original sample set of the second participant, in which the first sample subset and the second sample subset are used for model training based on federated learning of the first trainer and the second trainer.

Computer program codes for performing the operations of the present disclosure may be written in one or more programming languages or a combination thereof, the programming languages include, but are not limited to, object-oriented programming languages such as Java, Smalltalk and C++, and further include conventional procedural programming languages such as “C” programming language or similar programming languages. The program codes may be entirely executed on a user's computer, partially executed on the user's computer, executed as an independent software package, partially executed on the user's computer and partially executed on a remote computer, or entirely executed on the remote computer or a server. In the case involving the remote computer, the remote computer may be connected to the user's computer through any type of network, including a local area network (LAN) or a wide area network (WAN), or may be connected to an external computer (for example, through the Internet using an Internet service provider).

The flowcharts and block diagrams in the accompanying drawings illustrate the architecture, function and operation of possible implementations of the systems, methods and the computer program product according to various embodiments of the present disclosure. In this regard, each block in the flowcharts or block diagrams may represent a module, a program segment, or a part of codes, which includes one or more executable instructions for implementing specified logical functions. It should also be noted that, in some alternative implementations, the functions noted in the blocks may occur out of the order noted in the accompanying drawings. For example, two blocks illustrated in succession may, in fact, be executed substantially in parallel, and may sometimes be executed in a reverse order, depending on the function involved. It should also be noted that, each block in the block diagrams and/or flowcharts, and combinations of blocks in the block diagrams and/or flow diagrams, may be implemented by a dedicated hardware-based system that performs specified functions or operations, or by a combination of dedicated hardware and computer instructions.

The involved modules described in the embodiments of the present disclosure may be implemented by a mode of software, or may be implemented by a mode of hardware. Herein, the name of the module does not constitute a limitation on the module itself in a certain situation, for example.

The functions described above in this article may be at least partially executed by one or more hardware logic components. For example, non-restrictive exemplary types of the hardware logic component that may be used include: a field programmable gate array (FPGA), an application specific integrated circuit (ASIC), an application specific standard product (ASSP), a system on chip (SOC), a complex programmable logic device (CPLD) and the like.

In the context of the present disclosure, the machine-readable medium may be a tangible medium that may include or store a program used by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, device or device, or any suitable combination of the above. More specific examples of the machine-readable storage medium may include an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

Furthermore, although various operations are depicted in a particular order, this should not be understood as requiring that these operations be performed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims. With regard to the apparatus in the above embodiment, the specific way in which each module performs the operation has been described in detail in the embodiment of the method, and will not be described in detail here.

What is claimed:

1. A model training method based on federated learning, wherein the method is applied to a first trainer which is a trainer of a first participant with a label, and the method comprises:
acquiring a sample intersection identifier list, wherein the sample intersection identifier list comprises an identifier corresponding to each sample in a sample intersection obtained after a sample alignment for the first participant with a second participant without a label;
determining a first sample subset and a sample subset identifier corresponding to the first sample subset based on the sample intersection identifier list and an original sample subset, wherein the original sample subset comprises a sample distributed to the first trainer, and the original sample subset comprises a part of original samples of the first participant; and
transmitting the sample subset identifier to a second trainer paired with the first trainer, so as to enable the second trainer to determine a second sample subset based on the sample subset identifier and an original sample set of the second participant, wherein the second trainer is a trainer of the second participant, and the first sample subset and the second sample subset are used for model training based on federated learning of the first trainer and the second trainer.

2. The method according to claim 1, wherein determining the first sample subset based on the sample intersection identifier list and the original sample subset, comprises:
in the original sample subset, determining a sample with a sample identifier belonging to the sample intersection identifier list as being comprised in the first sample subset.

3. The method according to claim 1, further comprising:
after the first trainer is started, transmitting a registration request to a task controller, so as to enable the task controller to determine the second trainer paired with the first trainer in response to the registration request.

4. The method according to claim 3, further comprising:
transmitting a polling request for a pairing state to the task controller, so as to enable the task controller to transmit, in response to the polling request, a trainer identifier of the second trainer to the first trainer after determining the second trainer paired with the first trainer,
wherein transmitting the sample subset identifier to the second trainer paired with the first trainer, comprises: transmitting the sample subset identifier to the second trainer corresponding to the trainer identifier.

5. The method according to claim 3, wherein the first trainer and the second trainer which are paired are determined through the task controller by:
in response to both a first to-be-paired list and a second to-be-paired list being non-null, randomly selecting a first identifier from the first to-be-paired list, randomly selecting a second identifier from the second to-be-paired list, and taking a trainer corresponding to the first identifier and a trainer corresponding to the second identifier as the first trainer and the second trainer which are paired, respectively,
wherein the first to-be-paired list is used for storing an identifier of the trainer of the first participant that transmits the registration request, and the second to-be-paired list is used for storing an identifier of the trainer of the second participant that transmits the registration request.

6. The method according to claim 4, further comprising:
in a case that the polling request is transmitted to the task controller and the trainer identifier transmitted by the task controller is not received within a first preset duration, or in a case that the sample subset identifier is transmitted to the second trainer corresponding to the trainer identifier and a feedback message transmitted by the second trainer is not received within a second preset duration, transmitting a new registration request to the task controller, so as to enable the task controller to re-determine the second trainer paired with the first trainer in response to the new registration request.

7. A model training method based on federated learning, wherein the method is applied to a second trainer which is a trainer of a second participant without a label, and the method comprises:
acquiring a sample subset identifier transmitted by a first trainer, wherein the first trainer is a trainer, paired with the second trainer, in a first participant with a label, the sample subset identifier is determined by the first trainer based on a sample intersection identifier list and an original sample subset, the original sample subset comprises a sample distributed to the first trainer, the original sample subset comprises a part of original samples of the first participant, and the sample intersection identifier list comprises an identifier corresponding to each sample in a sample intersection obtained after a sample alignment performed for the first participant with the second participant; and
determining a second sample subset based on the sample subset identifier and an original sample set of the second participant, wherein the first sample subset and the second sample subset are used for model training based on federated learning of the first trainer and the second trainer.

8. The method according to claim 7, further comprising:
acquiring a cached sample set, wherein the cached sample set comprises a sample, with a sample identifier belonging to the sample intersection identifier list, in the original sample set of the second participant,
wherein determining the second sample subset based on the sample subset identifier and the original sample set of the second participant, comprises:
in the cached sample set, determining a sample with a sample identifier belonging to the sample subset identifier as being comprised in the second sample subset.

9. The method according to claim 8, wherein each sample in the cached sample set is stored in a form of a key-value pair, the sample identifier of the sample is a keyword, and a sample feature of the sample is a value corresponding to the keyword.

10. The method according to claim 7, further comprising:
after the second trainer is started, transmitting a registration request to a task controller, so as to enable the task controller to determine the first trainer paired with the second trainer in response to the registration request.

11. The method according to claim 10, further comprising:
transmitting a polling request for a pairing state to the task controller, so as to enable the task controller to transmit, in response to the polling request, a trainer identifier of the first trainer to the second trainer after determining the first trainer paired with the second trainer; and
in response to receiving the trainer identifier of the first trainer, blocking to wait for the sample subset identifier transmitted by the first trainer.

12. A computer-readable storage medium, wherein a computer program is stored on the computer-readable storage medium, and the computer program, when executed by a processing apparatus, causes the processing apparatus to implement the method according to claim 1.

13. A computer-readable storage medium, wherein a computer program is stored on the computer-readable storage medium, and the computer program, when executed by a processing apparatus, causes the processing apparatus to implement the method according to claim 7.

14. An electronic device, comprising:
a storage apparatus, wherein a computer program is stored on the storage apparatus; and
a processing apparatus, configured to execute the computer program stored on the storage apparatus to implement:
acquiring a sample intersection identifier list, wherein the sample intersection identifier list comprises an identifier corresponding to each sample in a sample intersection obtained after a sample alignment for a first participant with a second participant without a label;
determining a first sample subset and a sample subset identifier corresponding to the first sample subset based on the sample intersection identifier list and an original sample subset, wherein the original sample subset comprises a sample distributed to a first trainer, and the original sample subset comprises a part of original samples of the first participant; and
transmitting the sample subset identifier to a second trainer paired with the first trainer, so as to enable the second trainer to determine a second sample subset based on the sample subset identifier and an original sample set of the second participant, wherein the second trainer is a trainer of the second participant, and the first sample subset and the second sample subset are used for model training based on federated learning of the first trainer and the second trainer.

15. The electronic device according to claim 14, wherein determining the first sample subset based on the sample intersection identifier list and the original sample subset, comprises:
in the original sample subset, determining a sample with a sample identifier belonging to the sample intersection identifier list as being comprised in the first sample subset.

16. The electronic device according to claim 14, wherein the processing apparatus is configured to execute the computer program stored on the storage apparatus to further implement:
after the first trainer is started, transmitting a registration request to a task controller, so as to enable the task controller to determine the second trainer paired with the first trainer in response to the registration request.

17. The electronic device according to claim 16, wherein the processing apparatus is configured to execute the computer program stored on the storage apparatus to further implement:
transmitting a polling request for a pairing state to the task controller, so as to enable the task controller to transmit, in response to the polling request, a trainer identifier of the second trainer to the first trainer after determining the second trainer paired with the first trainer,
wherein transmitting the sample subset identifier to the second trainer paired with the first trainer, comprises: transmitting the sample subset identifier to the second trainer corresponding to the trainer identifier.

18. The electronic device according to claim 16, wherein the first trainer and the second trainer which are paired are determined through the task controller by:
in response to both a first to-be-paired list and a second to-be-paired list being non-null, randomly selecting a first identifier from the first to-be-paired list, randomly selecting a second identifier from the second to-be-paired list, and taking a trainer corresponding to the first identifier and a trainer corresponding to the second identifier as the first trainer and the second trainer which are paired, respectively,
wherein the first to-be-paired list is used for storing an identifier of the trainer of the first participant that transmits the registration request, and the second to-be-paired list is used for storing an identifier of the trainer of the second participant that transmits the registration request.

19. The electronic device according to claim 17, wherein the processing apparatus is configured to execute the computer program stored on the storage apparatus to further implement:
in a case that the polling request is transmitted to the task controller and the trainer identifier transmitted by the task controller is not received within a first preset duration, or in a case that the sample subset identifier is transmitted to the second trainer corresponding to the trainer identifier and a feedback message transmitted by the second trainer is not received within a second preset duration, transmitting a new registration request to the task controller, so as to enable the task controller to re-determine the second trainer paired with the first trainer in response to the new registration request.

20. An electronic device, comprising:
a storage apparatus, wherein a computer program is stored on the storage apparatus; and
a processing apparatus, configured to execute the computer program stored on the storage apparatus to implement the method according to claim 7.
